(19) United States
(12) Patent Application Publication
(10) Pub. No.: US 2026/0089276 A1
(43) Pub. Date: Mar. 26, 2026

(54) IMAGE FORMING APPARATUS, IMAGE FORMING SYSTEM, AND METHOD OF CONTROLLING IMAGE FORMING APPARATUS

(71) Applicant: CANON KABUSHIKI KAISHA, Tokyo (JP)

(72) Inventor: KATSUYUKI MURAKAMI, Chiba (JP)

(21) Appl. No.: 19/332,398

(22) Filed: Sep. 18, 2025

(30) Foreign Application Priority Data
Sep. 25, 2024 (JP) 2024-166561

(51) Int. Cl. H04N 1/00

(52) U.S. Cl. CPC H04N 1/00623; H04N 1/00005; H04N 1/00641; H04N 2201/0094

(57) ABSTRACT

An image forming apparatus that forms an image on a plurality of sheets, reads the plurality of sheets on which the image has been formed, obtains a result of determination as to whether there is an abnormality on the read plurality of sheets, and based on the obtained determination result, output the plurality of sheets such that a sheet determined to have an abnormality among the plurality of sheets can be identified.

### BACKGROUND

### Field of the Technology

The present disclosure relates to an image forming apparatus, an image forming system, and a method of controlling an image forming apparatus.

### Description of the Related Art

Inspection apparatuses that use a scanner or the like to read a sheet on which an image has been formed, and automatically perform image formation quality inspection (primary inspection) have been developed. Inspection content relates to the presence or absence of stains on a formation target (e.g., a pattern, a character, a barcode, etc.), the legibility or order of page numbers assigned across multiple pages, and the like. The inspection apparatuses discharge sheets determined to have an abnormality (hereinafter, referred to as NG sheets) and sheets determined to have no abnormalities (hereinafter, referred to as OK sheets) to respective different trays.

Incidentally, when an NG sheet is visually confirmed to have no abnormalities in secondary inspection, or when an image formed on an NG sheet is re-formed on another sheet, which is then confirmed to have no abnormalities, the sheet confirmed to have no abnormalities is returned to its original position between the OK sheets stacked on the tray. However, there are no marks for the return position on the stacked OK sheets. Therefore, the worker performs the task carefully so as not to return the sheet confirmed to have no abnormalities to the wrong position between the stacked OK sheets, and therefore their workload increases. Japanese Patent Laid-Open No. 2022-145188 describes a technique in which, when NG sheets and OK sheets are discharged to respective different trays, an insert sheet, with an ID, that serves as a mark for the position where the NG sheet occurred is inserted between OK sheets discharged to the tray and stacked.

In the technique described in Japanese Patent Laid-Open No. 2022-145188, an insert sheet inserted between the stacked OK sheets serves as a mark for a page where the NG sheet occurred. Therefore, the worker's burden in returning the sheet confirmed to have no abnormalities in secondary inspection to the position where the NG sheet occurred in the stacked OK sheet is reduced. However, since an insert sheet is used, it results in paper consumption.

### SUMMARY

The present disclosure enables realization of a novel mechanism for reducing the burden in returning a sheet confirmed to have no abnormalities in image forming quality in secondary inspection, for example, to its original position between sheets stacked after being determined to have no abnormalities in primary inspection, and for reducing paper consumption.

One aspect of the present disclosure provides an image forming apparatus comprising: one or more memory devices that store a set of instructions; and one or more processors that execute the set of instructions to: form an image on a plurality of sheets; read the plurality of sheets on which the image has been formed; obtain a result of determination as to whether there is an abnormality on the read plurality of sheets; and based on the obtained determination result, output the plurality of sheets such that a sheet determined to have an abnormality among the plurality of sheets can be identified, wherein the one or more processors execute instructions in the one or more memory devices to: perform control so as to output a first sheet determined to have no abnormalities and a second sheet determined to have an abnormality to respective different discharge units, and among first sheets, shift at least one sheet preceding/succeeding the second sheet as a mark sheet in a first direction and output the sheet.

Another aspect of the present disclosure provides a method of controlling an image forming apparatus, the method comprising: forming an image on a plurality of sheets; reading the plurality of sheets on which the image has been formed; obtaining a result of determination as to whether there is an abnormality on the read plurality of sheets; and based on the obtained determination result, outputting the plurality of sheets such that a sheet determined to have an abnormality among the plurality of sheets can be identified, wherein control is performed so as to output a first sheet determined to have no abnormalities and a second sheet determined to have an abnormality to respective different discharge units, and among first sheets, at least one sheet preceding/succeeding the second sheet is shifted as a mark sheet in a first direction and output the sheet.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic diagram of an inspection system according to one embodiment.

FIG. 2 is a diagram illustrating a detailed block configuration of an image forming apparatus according to one embodiment.

FIG. 3 is a flowchart for explaining a processing procedure according to one embodiment.

FIG. 4 is a flowchart for explaining a processing procedure according to one embodiment.

FIG. 5 is a diagram illustrating an internal structure of an image forming apparatus according to one embodiment.

FIG. 6 is a diagram illustrating a display screen according to one embodiment.

FIG. 7 is a diagram illustrating a display screen according to one embodiment.

FIG. 8 is a flowchart for explaining a processing procedure according to one embodiment.

FIG. 9 is a flowchart for explaining a processing procedure according to one embodiment.

FIGS. 10A and 10B are schematic diagrams of printed materials according to one embodiment.

FIG. 11 is a schematic diagram of printed materials according to one embodiment.

FIG. 12 is a diagram illustrating a display screen according to one embodiment.

FIG. 13 is a diagram illustrating a display screen according to one embodiment.

FIG. 14 is a schematic diagram of printed materials according to one embodiment.

FIGS. 15A and 15B are schematic diagrams of printed materials according to one embodiment.

FIG. 16 is a flowchart for explaining a processing procedure according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In this specification, the term “image forming apparatus” broadly includes apparatuses for forming (printing) an image on a printing material (printing medium), such as single function printers, copy machines, multifunction peripherals, and commercial printers.

### <Configuration of System>

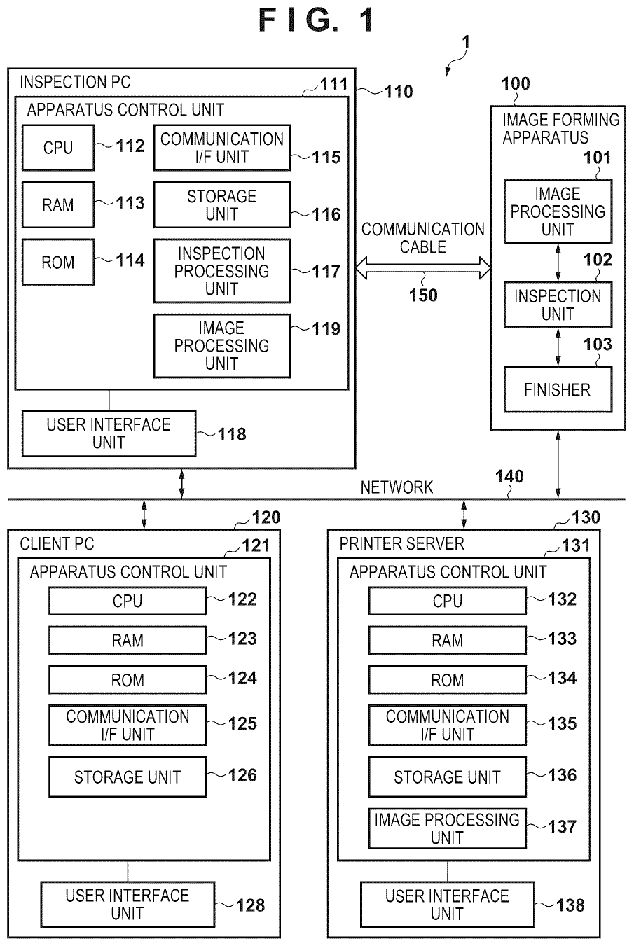

An overview of an inspection system 1 (an example of an “image forming system”) according to the present embodiment will be described with reference to FIG. 1. The inspection system 1 is configured to include an image forming apparatus 100, an inspection Personal Computer (PC) 110 (an example of an “inspection apparatus”), a client PC 120, and a printer server 130. Further, these apparatuses are connected to each other via a network 140. Further, the image forming apparatus 100 and the inspection PC 110 are connected via a communication cable 150. The inspection PC 110, a combination of the inspection PC 110 and an inspection unit 102, or a combination of the image forming apparatus 100 and the inspection PC 110 are hereinafter also referred to as an inspection apparatus.

### <Image Forming Apparatus 100>

The image forming apparatus 100 is configured to include an image processing unit 101 (an example of an “image forming unit”), the inspection unit 102 (an example of an “obtaining unit”), and a finisher 103 (an example of an “output unit”). These are connected to each other via a communication cable, which is an internal bus. The image forming apparatus 100 performs printing using various types of input data, such as original data transmitted from the client PC 120 or the printer server 130. Further, the image forming apparatus 100 is connected to the inspection PC 110 via the communication cable 150 and communicates with the inspection PC 110 regarding image data at the time of inspection, inspection results, and the like.

More specifically, the image processing unit 101 performs image processing in accordance with print settings based on various kinds of input data and outputs a printing sheet, on which an image subjected to image processing has been printed, as a printed material. The inspection unit 102 receives the printed material outputted from the image processing unit 101, and scans and reads the printed material to obtain a read image (scan image). The read image obtained here is image data for inspecting in the inspection PC 110 whether there is an abnormal image. Here, an abnormal image is something that decreases the quality of a printed material, for example, and more specifically, is a circular abnormal image (also referred to as a “spot”) caused by a coloring material adhering to an unintended part at the time of printing, a color omission caused by not enough coloring material adhering to an intended part, or a linear abnormal image (also referred to as a “streak”).

The read image data is transferred to the inspection PC 110, which will be described later, via the communication cable 150, and inspection as to whether there is an abnormal portion in the image data is executed in the inspection PC 110. Then, the inspection unit 102 of the image forming apparatus 100 obtains a result of the inspection from the inspection PC 110. The finisher 103 receives the sheet for which inspection has been completed by the inspection unit 102 and switches the discharge destination based on the inspection result.

Although the inspection is performed in the inspection PC 110, which is different from the image forming apparatus 100, an in-line inspection machine that performs image forming, inspection, post-processing, and discharge from start to finish may be provided as an alternative to the image forming apparatus 100 and the inspection PC 110.

### <Inspection PC 110>

The inspection PC 110 is a PC for inspecting images read from printed materials in the inspection unit 102. The inspection PC 110 is configured to include an apparatus control unit 111 and a user interface unit 118 (hereinafter, also referred to as a UI). The inspection PC 110 executes inspection of pictures captured in the image (hereinafter referred to as image inspection) and inspection of symbols captured in the image (hereinafter referred to as data inspection). Symbols are characters, signs, and codes (e.g., barcodes), for example.

More specifically, the apparatus control unit 111 is configured to include a controller board. That is, a CPU 112, a RAM 113, a ROM 114, a communication I/F unit 115 (an example of a “communication unit”), a storage unit 116, an inspection processing unit 117 (an example of a “determination unit”), and an image processing unit 119 are mounted on the apparatus control unit 111. In the present embodiment, it is assumed that communication between these modules is performed via an internal system bus (not illustrated).

The CPU 112 reads a main program from the storage unit 116 in accordance with an initial program in the storage unit 116 and stores the main program in the RAM 113. The RAM 113 is used for storing programs and as a main memory for work. Further, the ROM 114 is used to temporarily store data created while processing programs. The communication I/F unit 115 is configured to include a communication module, such as a Network Interface Card (NIC), and communicates data with an external apparatus via the network 140 or the communication cable 150. The storage unit 116 is configured to include a Hard Disk Drive (HDD) and is used to store data such as programs and high-volume data such as image data.

The inspection processing unit 117 calculates a difference value between inspection target image data obtained from the inspection unit 102 of the image forming apparatus 100 and reference image data stored in the RAM 113. Further, the inspection processing unit 117 compares the calculated difference value with an inspection threshold of each inspection item (e.g., contrast and size) for each pixel. Then, the inspection processing unit 117 stores an inspection result (determination result) in the RAM 113. The inspection result is information on whether there is an abnormality in a printed material, for example, and if it is determined that there is an abnormality, position information of an abnormal portion at the time of displaying the type of the abnormality (e.g., spot, streak, or color omission) on the user interface unit 118, for example. The inspection result is transmitted to the inspection unit 102 via the communication cable 150 by the communication I/F unit.

The image processing unit 119 performs image processing for converting the image data into an optimum resolution for inspection. That is, the image processing unit 119 rasterizes the data and converts it to a bitmap image. The user interface unit 118 is configured to include a keyboard, a mouse, a display, and other input/output apparatuses, for example, and can input various setting values or designated values.

### <Client PC 120>

The client PC 120 is a PC that is connected to the inspection PC 110 and the printer server 130 and accepts operations by a user. More specifically, the client PC 120 includes an apparatus control unit 121 and a user interface unit 128. The apparatus control unit 121 is configured to include a controller board. A CPU 122, a RAM 123, a ROM 124, a communication I/F unit 125, and a storage unit 126 are mounted on the apparatus control unit 121. The roles of each element provided in the client PC 120 are similar to those of the inspection PC 110.

### <Printer Server 130>

The printer server 130 is a server that performs RIP processing for printing original data or document data. Further, the printer server 130 performs control related to printing of the image forming apparatus 100 and manages print jobs.

More specifically, the printer server 130 is configured to include an apparatus control unit 131 and a user interface unit 138. That is, the apparatus control unit 131 is configured to include a controller board. A CPU 132, a RAM 133, a ROM 134, a communication I/F unit 135, a storage unit 136, and an image processing unit 137 are mounted on the apparatus control unit 131. The image processing unit 137 executes RIP processing for printing according to print settings on original data or document data transmitted from the client PC 120 and converts it into bitmapped image data. The RIP processing for printing is, for example, processing for generating an image without reducing the 600-dpi resolution. The roles of other elements of the printer server 130 are similar to those of the elements of the client PC 120.

### <Detailed Block Configuration of Image Forming Apparatus 100>

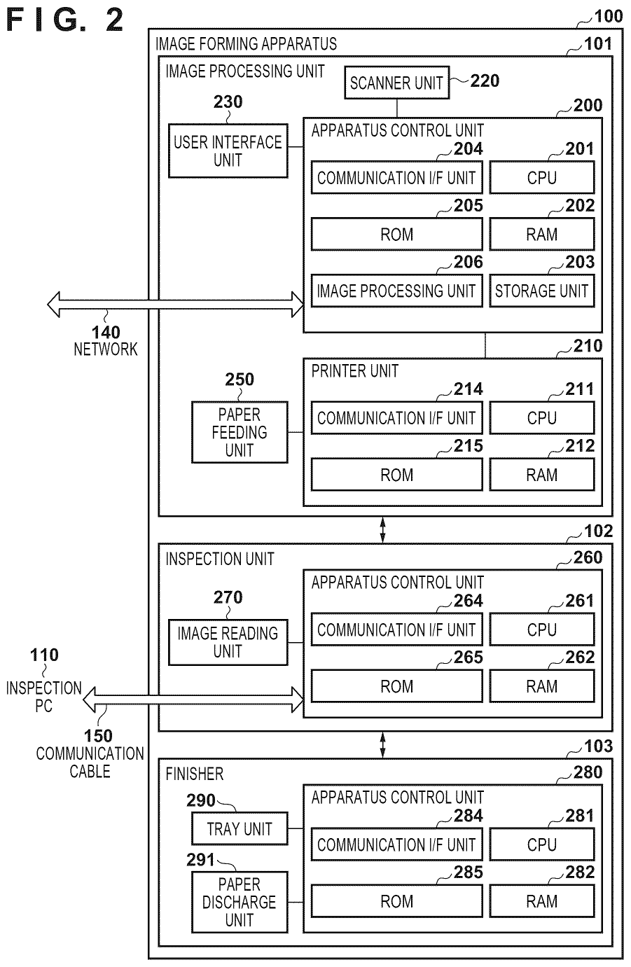

A detailed block of the image forming apparatus 100 will be described with reference to FIG. 2. The image processing unit 101 is configured to include an apparatus control unit 200, a printer unit 210, a scanner unit 220, a user interface unit 230, and a paper feeding unit 250.

The apparatus control unit 200 receives an image or a document via the network 140 and converts it into print data. More specifically, a CPU 201, a RAM 202, a storage unit 203, a communication I/F unit 204, a ROM 205, and an image processing unit 206 are mounted on the apparatus control unit 200. The image processing unit 206 obtains Page Description Language (PDL) data stored in the RAM 202 and performs image processing for converting it into print data. The image processing for conversion to print data is performing RIP processing on PDL data, for example, to convert it into multi-valued bitmap data, and further performing pseudo halftone processing, such as screen processing, to convert the multi-valued bitmap data to binary bitmap data. The binary bitmap data obtained by the image processing unit 206 is transmitted to the printer unit 210 via the communication I/F unit 204. The roles of other elements of the apparatus control unit 200 are similar to those of the elements of the printer server 130.

The printer unit 210 is configured to include a CPU 211, a RAM 212, a communication I/F unit 214, and a ROM 215. The roles of respective elements are similar to those of the elements of the apparatus control unit 200. The printer unit 210 conveys a sheet (a printing sheet or a printing medium) from the paper feeding unit 250. Further, the printer unit 210 receives binary bitmap data generated by the apparatus control unit 200 and prints it on the sheet by using a coloring material. At this time, the CPU 211 outputs a print instruction based on print settings designated by the user. For example, in the case of a print setting that uses coated paper, the CPU 211 outputs an instruction to print using a sheet cassette (not illustrated), in which coated paper is stored, in the paper feeding unit 250.

By the apparatus control unit 200 and the printer unit 210 thus controlling various processes from reception of the above PDL data to printing on a sheet, a full color toner image is formed on the sheet.

The scanner unit 220 illuminates an original with a light source (not illustrated) and obtains a read signal corresponding to an original reflected image, which has been obtained by using a Charge Coupled Device (CCD) sensor or the like, as red, green, and blue multi-valued image data. The user interface unit 230 is configured to include a keyboard, a mouse, a display, and other input/output apparatuses, for example, and can input various setting values or designated values. The paper feeding unit 250 includes one or more cassettes for setting sheets to be printed, and feeds a sheet from a cassette corresponding to the sheet size designated in the print settings and conveys it to the printer unit 210.

The inspection unit 102 is configured to include an apparatus control unit 260 and an image reading unit 270 (an example of a “reading unit”). The image reading unit 270 is an image reading unit that reads a printed material conveyed from the image processing unit 101. The image reading unit 270 illuminates an original, which is a printed material, with light from a light source (not illustrated). Then, the image reading unit 270 obtains read information obtained from a Contact Image Sensor (CIS) by using a unity magnification coupled system lens, as red, green, and blue multi-valued image data corresponding to an original reflected image. The image reading unit 270 is not limited to a CIS sensor and may obtain image data by using a CCD sensor, for example.

The apparatus control unit 260 is configured to include a CPU 261, a RAM 262, a communication I/F unit 264 (an example of a “transmission unit” and an “obtaining unit”), and a ROM 265. The roles of respective elements are similar to those of the elements of the apparatus control unit 200. The apparatus control unit 260 performs control for transferring image data obtained by the image reading unit 270 to the inspection PC 110 via the communication cable 150. The apparatus control unit 260 obtains an inspection result of whether there is an abnormality in the image data from the inspection PC 110 and transmits the inspection result to the finisher 103. The data transmitted to the inspection PC 110 includes bitmap data generated in the image processing unit 206. The bitmap data is used in the inspection PC 110 as a reference image that serves as inspection criteria for whether there is an abnormality in a printed material on which an original has been printed.

The finisher 103 is configured to include an apparatus control unit 280, a tray unit 290, and a paper discharge unit 291. More specifically, the apparatus control unit 280 is configured to include a CPU 281, a RAM 282, a communication I/F unit 284, and a ROM 285. The roles of each element of the apparatus control unit 280 are similar to those of each element of the apparatus control unit 260. The apparatus control unit 280 determines the discharge control to be performed by the tray unit 290 and the paper discharge unit 291 in consideration of print settings and an inspection result. The tray unit 290 and the paper discharge unit 291 are each an example of a “discharge unit”.

The tray unit 290 and the paper discharge unit 291 switch the discharge destination of a printed material conveyed from the inspection unit 102 based on the inspection result. For example, in the case of switching the discharge destination in accordance with whether there is an abnormality in a printed material, the finisher 103 discharges a printed material having no abnormalities to the normal tray unit 290 and discharges a printed material having an abnormality to the paper discharge unit 291, which is different from the normal tray unit 290. The finisher 103 switches the discharge destination based on the inspection result received from the inspection unit 102. In addition, the finisher 103 provides shift sorting, which facilitates recognition of a predetermined number of copies by shifting the discharge position for each predetermined number of copies when discharging them to the normal tray unit 290. The finisher 103 also provides group sorting, which facilitates recognition between different frames by shifting the discharge position when collectively printing an image of one frame split across a plurality of pages and then printing an image of another frame. The finisher 103 also provides rotation sorting, which facilitates recognition of a group of printed materials based on the orientation of sheets by changing the discharge orientation by 90 degrees, rather than just shifting the discharge position.

The image forming apparatus 100 is not limited to the present embodiment and need only be in a form that can print original data and read an image to inspect whether there is an abnormality in a printed material.

### <Internal Structure of Image Forming Apparatus>

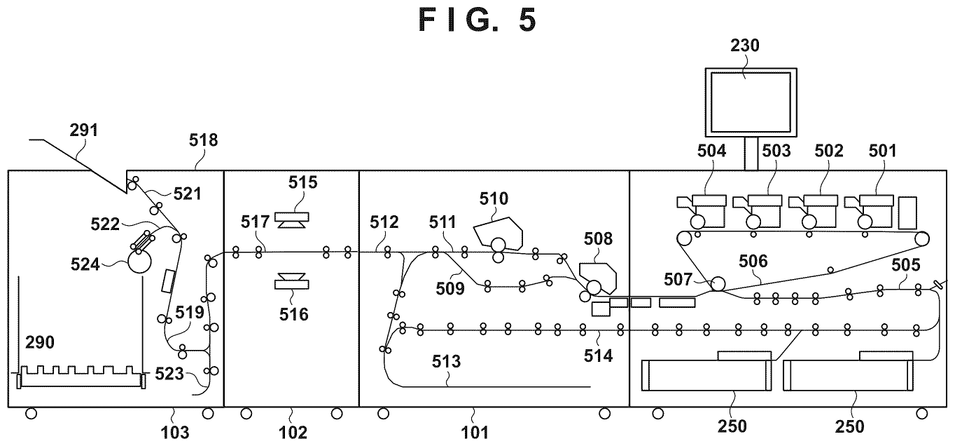

An internal structure of the image forming apparatus 100 will be described with reference to FIG. 5. The image processing unit 101 accepts input from the user via the user interface unit 230, which is a UI panel, and displays printing and device states. The paper feeding unit 250 can accommodate various types of sheets. The paper feeding unit 250 can separate only one sheet at the top of the accommodated sheets and convey it to a sheet conveyance path 505.

Developing stations 501 to 504 respectively form toner images by using Y, M, C, and K color toners to form color images. The toner images formed here are primarily transferred to an intermediate transfer belt 506. By the intermediate transfer belt 506 being rotated clockwise in FIG. 5, the toner images are transferred to the sheet conveyed from the sheet conveyance path 505 at a secondary transfer position 507.

A fixing unit 508 is configured to include a pressing roller and a heating roller, and melts and presses the toner to the sheet when the sheet passes between the rollers. By doing so, the toner images are fixed to the sheet. The sheet, which has exited the fixing unit 508, is conveyed through a sheet conveyance path 509 to a connection point 512 with the inspection unit 102. When further melting and pressing are necessary for fixing depending on the type of sheet, the sheet, after passing through the fixing unit 508, is conveyed to a second fixing unit 510 by using an upper sheet conveyance path. Then, the sheet, after being subjected to additional melting and pressing, is conveyed through a sheet conveyance path 511 to the connection point 512 with the inspection unit 102. When the image forming mode is double-sided, the sheet is conveyed to a sheet reversing path 513 and, after being reversed in the sheet reversing path 513, is conveyed to a double-sided conveyance path 514, and an image is transferred to the second side at the secondary transfer position 507.

In the inspection unit 102, CISs 515 and 516, which are the image reading unit 270, are arranged in a form in which they are facing each other. The CIS 515 is a sensor for reading the upper side of the sheet and the CIS 516 is a sensor for reading the lower side of the sheet. The inspection unit 102 scans a sheet conveyed to a sheet conveyance path 517 by using the CISs 515 and 516 at the timing when the sheet reaches a predetermined position.

The finisher 103 is a high-capacity stacker capable of stacking a high volume of sheets. The finisher 103 includes the tray unit 290 as a tray on which sheets are to be stacked. A sheet that has passed through the inspection unit 102 enters the finisher 103 through a sheet conveyance path 519. The sheet passes through the sheet conveyance path 519, a reversing unit 523, a sheet conveyance path 522, and a reversing unit 524 in that order and is stacked on the tray unit 290. The finisher 103 further includes the paper discharge unit 291 as a paper discharge tray. The CPU 281 discharges a sheet on which an abnormality has been detected by the inspection unit 102 to the paper discharge unit 291. When discharging a sheet to the paper discharge unit 291, the sheet is conveyed from the sheet conveyance path 519 to the paper discharge unit 291 through the reversing unit 523 and a sheet conveyance path 521 in that order.

Here, the reversing unit 523 is a reversing unit for reversing a sheet. Further, the reversing unit 524 is a reversing unit that performs something equivalent to reversal by flipping a sheet with the end of the sheet on the leading side in the conveyance direction of the sheet as the leading end. The reversing unit 523 and the reversing unit 524 are used when stacking a sheet in the tray unit 290. When stacking a sheet in the tray unit 290, the sheet is first reversed by the reversing unit 523 and further reversed again by the reversing unit 524 such that the orientation of the sheet at the time of entering and the orientation of the sheet at the time of loading are the same. In addition, when shifting a sheet, the reversing unit 524 moves the sheet in a direction perpendicular to the conveyance direction of the sheet and parallel to the sheet surface, simultaneously with the reversal of the sheet. The movement amount may be a minimum of 20 mm (an example of “predetermined amount”), for example, so as to be distinguishable from errors in the stacking position caused by sheet conveyance or the like. Such a movement amount may be changed in accordance with the size of the sheet or the accuracy of error. By doing so, a predetermined sheet is shifted in the direction of the sheet surface and discharged.

The present disclosure is not limited to such a configuration, and for example, a sheet guide (not illustrated) for shifting the position of a sheet may be provided in the tray unit 290. In addition, regarding sheet shifting, there is a case in which the sheet position is shifted in a direction parallel to the sheet surface and perpendicular to the conveyance direction of the sheet. The reason for this is that, if a sheet is to be shifted in a direction parallel to the conveyance direction of the sheet, control for stopping the sheet at an accurate position will be necessary. In other words, if there is a shift apparatus capable of performing control for stopping a sheet at an accurate position, regarding the direction in which the sheet is shifted it is easy to shift it in a direction parallel to the conveyance direction of the sheet.

### Processing Example 1

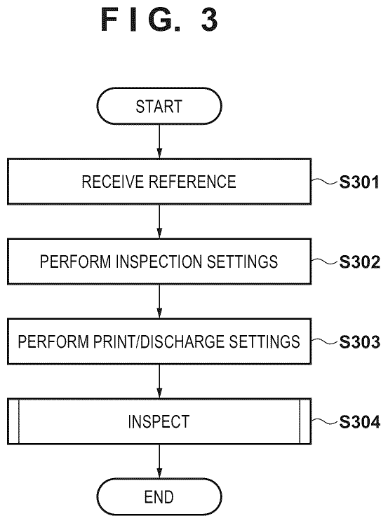

A flowchart of processing for operations before starting inspection, inspection execution, and inspection reporting in the inspection PC 110 will be described with reference to FIG. 3. Such processing is executed by program code stored in the storage unit 116 being deployed in the RAM 113 and the CPU 112 controlling the apparatus control unit 111, in response to the user operating the user interface unit 118.

In step S301, the CPU 112 of the inspection PC 110 receives a reference by using the communication I/F unit 115. Then, the CPU 112 stores the reference in the storage unit 116. Here, the reference includes a reference image used in the case of image inspection or reference data used in the case of data inspection. The reference need not include either the reference image or the reference data. In such a case, the inspection for which a reference is not present will not be performed. For example, if the reference includes only a reference image, data inspection will not be performed.

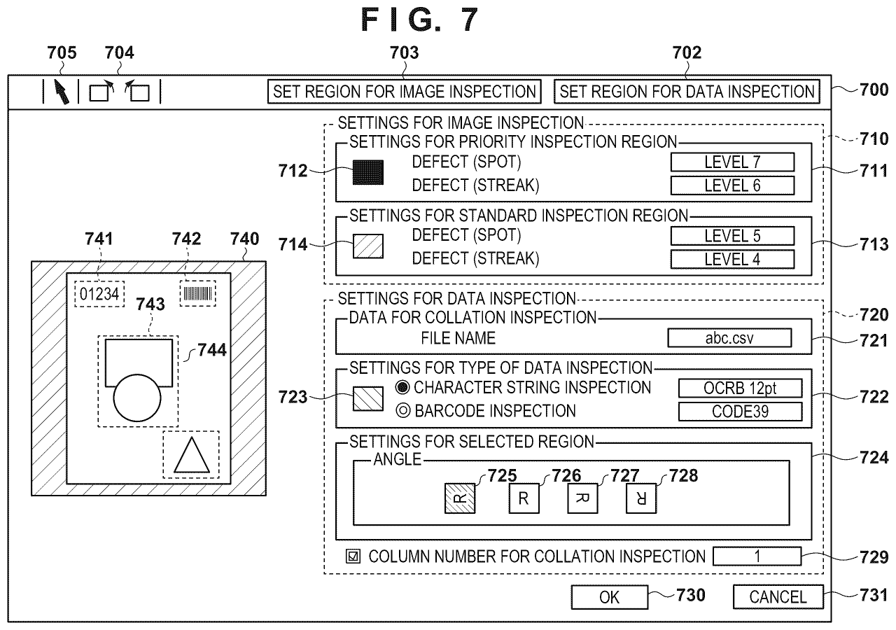

In step S302, the CPU 112 obtains inspection setting information via the user interface unit 118 and stores it in the storage unit 116. The inspection setting information is detailed information such as an inspection region, an inspection type, and an inspection level for a printed image, for example. The details of the inspection setting information will be described later in FIG. 7.

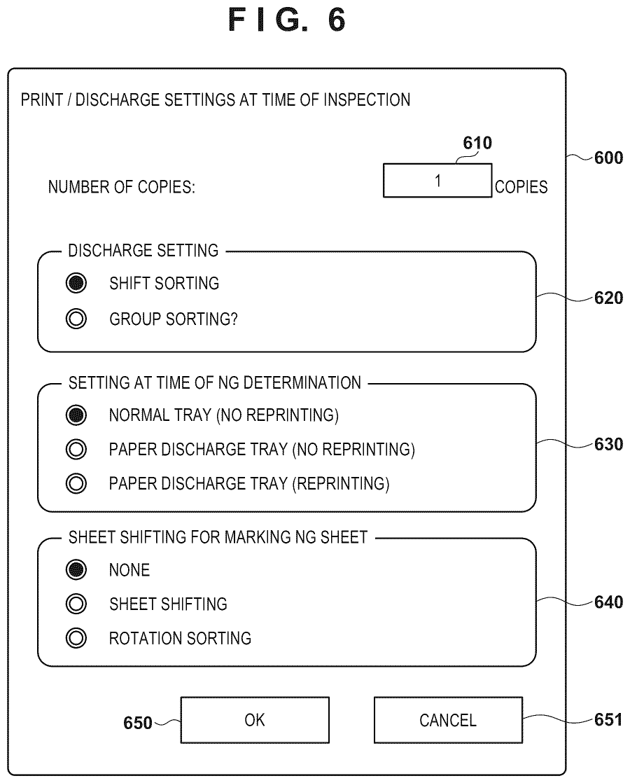

In step S303, the CPU 112 performs print/discharge settings at the time of inspection. The print/discharge settings include, for example, settings for the number of copies and a method of discharging a printed material determined to be have passed the inspection (“inspection OK”). Further, the print/discharge settings include switching the discharge at the time of inspection failure (“inspection NG”) determination, setting for whether to reprint, and setting for whether to shift a sheet to identify the position where inspection NG occurred. The details of print/discharge settings will be described later in FIG. 6.

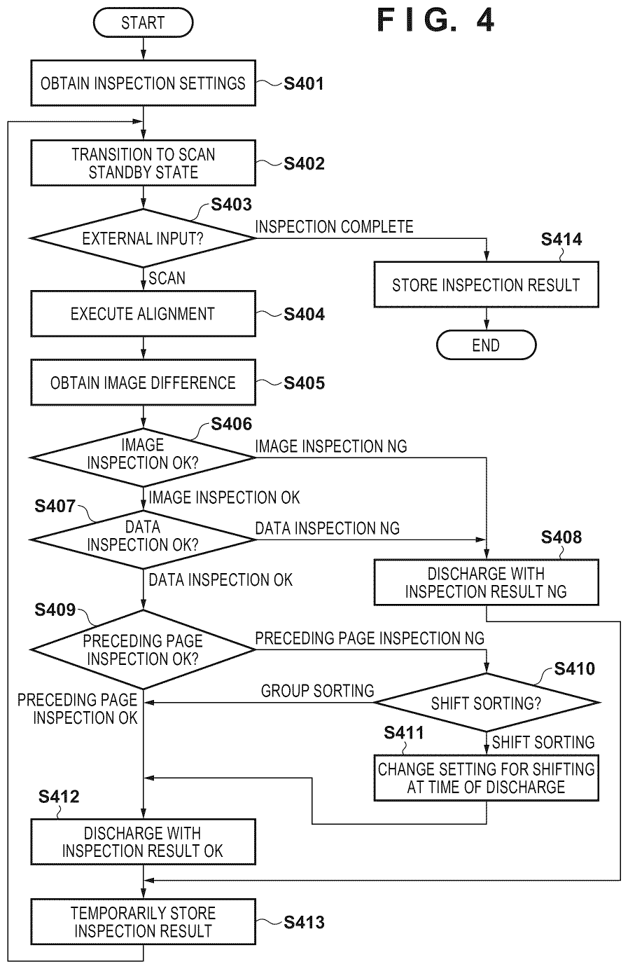

In step S304, the CPU 112 compares the reference received in step S301 with the inspection target, and determines whether the quality of the inspection target is OK or NG. The details of such inspection will be described later in FIG. 4.

### <UI Related to Inspection Settings>

A UI that displays the inspection setting information in step S302 will be described with reference to FIG. 7. In step S302, the CPU 112 displays a UI screen 700 illustrated in FIG. 7 on the user interface unit 118 at the timing when inspection settings are performed. More specifically, a page preview 740 displayed on the UI screen 700 is a display screen that displays a reference picture read in step S301.

A button 702 is displayed to be touch-operable by the user when setting a region for data inspection. A method of setting a region for data inspection is the following procedure. First, the user touches “set region for data inspection” of the button 702. Next, the user designates regions where data inspection is to be performed in the page preview 740. Then, the CPU 112 sets corresponding designated ranges as a data inspection region 741 and a data inspection region 742. A data inspection region is an inspection region in which the type of a set symbol (character string or barcode) is read and correctness is determined.

A button 703 is displayed to be touch-operable by the user when setting an inspection region of a printed image (hereinafter, referred to as an image inspection region). A method of setting a region for image inspection is the following procedure. First, the user touches “set region for image inspection” of the button 703. Next, the user designates regions where image inspection is to be performed in the page preview 740. Then, the CPU 112 sets corresponding designated ranges as an image inspection region 743 and an image inspection region 744. An image inspection region is an inspection region in which an abnormal image of a picture portion of a printed material is detected.

Further, a detection level can be switched for each region by a method, which will be described later. Buttons 704 are buttons for rotating an image displayed in the page preview 740. A button 705 is a button for selecting an inspection region and is displayed to be operable by the user when they want to change setting information for a region that has already been set.

A UI 710 is displayed to include a UI 711 and a UI 713. The UI 710 is a group of UIs for setting the levels of abnormal images to be detected when performing image inspection. More specifically, the UI 711 included in the UI 710 is a UI for setting detection items for detecting abnormal images in image inspection and the detection levels thereof for priority inspection regions. The detection items for image inspection are items related to features of abnormal images to be detected when inspecting a printed material, such as circular abnormal images (hereinafter also referred to as a “spot”) and linear abnormal images (hereinafter also referred to as a “streak”).

Further, a detection level is a parameter that sets the size at which a detected abnormal image is determined to be an abnormal image, in stages, for a respective feature. For example, the detection level is divided into nine stages from level 1 to level 9, and level 9 is a level at which it is possible to detect lighter and smaller abnormal images than at level 1. Further, a level can be set for each inspection item, such as inspection level 7 for a spot and inspection level 6 for a streak, for example. Further, the image inspection region 743 in the page preview 740 indicates a region that has been set as a priority inspection region.

Further, a UI 712 included in the UI 711 is a UI for displaying the color of the frame when the image inspection region 743, which is set as a priority inspection region, is surrounded by the frame. That is, the color of the frame surrounding the image inspection region 743 is a color corresponding to the color displayed in the UI 712. A method of identifying the image inspection region 743 is not limited to coloring the frame and may be a method of switching a pattern or a line expression method.

Further, the UI 713 included in the UI 710 is a UI for setting detection items for detecting abnormal images in image inspection and the detection levels thereof for standard inspection regions. The UI 713 indicated in FIG. 7 shows an example in which the user has respectively selected level 5 for an inspection level setting for an abnormal image (spot) and level 4 for an inspection level setting for an abnormal image (streak). Further, the image inspection region 744 in the page preview 740 indicates a region that has been set as a standard inspection region. It is assumed that the detection levels are set such that the detection level of a priority inspection region is higher than the detection level of a standard inspection region. For example, when the detection level of an abnormal image (streak) for a standard inspection region is set to be 4, the detection level of an abnormal image (streak) for a priority inspection region is set to be at a level that is higher than 4. It is similar for a detection level setting for an abnormal image (spot).

Further, a UI 714 included in the UI 713 is a UI for displaying the color of the frame when a region set as a standard inspection region is surrounded by a frame. That is, the color of the frame surrounding the image inspection region 744 is a color corresponding to the color displayed in the UI 714. When performing print inspection in a state in which a plurality of inspection regions are set in an overlapped manner, the priority of the settings to be applied is in the order of those for the priority inspection region and those for the standard inspection region, for example. A configuration may be taken to allow a priority to be set for each inspection region, and if there are overlapping inspection regions, apply the settings for the inspection region displayed at the highest priority thereamong.

A UI 720 is displayed to include a UI 721, a UI 722, a UI 724, and a UI 729. The UI 720 is a group of UIs for setting a data file to be compared with detected data, the type of data inspection, and detailed information thereof when performing data inspection. A data inspection region is an inspection region in which the type of set data (character string or barcode), for example, is read and correctness is determined.

The UI 721 is a UI in which a variable data file to be used as reference character information when determining correctness in data inspection can be set by a file selection method. The variable data is a Comma Separated Values (CSV) file of a reference for data inspection that serves as a reference for comparison when performing data inspection, for example. The CSV file of a reference is a file that includes data in which reference character strings for character string inspection or barcode inspection are listed, separated by commas.

Further, data described in the CSV file of a reference is also used when generating original data of an inspection target, specifically, when generating original data of an inspection target includes a variable portion such as a character string or a barcode prior to inspection, as data of the variable portion. That is, when a plurality of pieces of original data are printed in order, the order of pieces of variable data described in the respective pieces of original data in the printing order coincides with the order of the data described in the CSV file of the reference. Therefore, when executing data inspection, inspection can be performed by comparing results of reading character string inspection regions and barcodes of the inspection target original data and the reference character strings listed in the CSV file of the reference. That is, when the printing order of the original data is changed, since the results of reading the character string inspection region and the barcodes of the original data do not coincide with the order of the data described in the CSV file of the reference, it can be determined as inspection NG. The UI 721 indicated in FIG. 7 shows an example in which data with a file name “abc.csv” has been selected as reference data for collation inspection. Further, the CSV file is stored in advance in the storage unit 116.

The UI 722 displays the type of inspection such that it can be set to character string inspection or barcode inspection by the user. The user can select the type of inspection by using a radio button method and a pull-down method. The type of character string is, for example, a font data set in which character glyph images are associated with character codes for character recognition (OCR). Such a set may be stored in advance in the storage unit 116 at the time of shipment. Alternatively, registration processing in which the user prints glyph images of characters and the printed glyph images are associated with character codes may be performed. In the UI 722 in FIG. 7, character string inspection is selected and the glyph font is set to OCRB 12 pt, for example. In addition, the data inspection region 741 in the page preview 740 is a region that displays the target of character string inspection in an identifiable manner.

Further, the type of barcode is a barcode standard supported by data inspection, for example. That is, one-dimensional barcodes such as CODE 39 and JAN, two-dimensional codes such as QR Codes® and Data Matrix codes can also be selected in the UI 722. The data inspection region 742 in the page preview 740 is a region that displays the target of barcode inspection in an identifiable manner.

Further, a UI 723 included in the UI 722 is a UI for displaying the color of the frame when a region set as a data inspection region is surrounded by a frame. That is, the color of the frames surrounding the respective data inspection regions 741 and 742 is a color corresponding to the color displayed by the UI 723. Although the color of the frames for character string inspection and barcode inspection is displayed in a uniform manner, the colors of the frames for character string inspection and barcode inspection may be set respectively.

The UI 724 is displayed such that a direction in which a character string or a barcode is read when performing data inspection can be set. The UI 724 is displayed to include direction setting buttons 725 to 728 by which a reading direction can be set. The direction setting buttons 725 to 728 can set reading directions rotated clockwise by 0°, 90°, 180°, and 270° relative to the sheet conveyance direction. That is, in the present embodiment, the sheet conveyance direction is a direction from right to left in the page preview 740 of FIG. 7. Further, a direction setting button whose reading direction coincides with the sheet conveyance direction is the button 725. Therefore, when the direction setting button 725 is touch-operated, an angle setting becomes 0°. Therefore, when rotating the reading direction by 90 degrees, the user needs to touch-operate the direction setting button 726. Similarly, when rotating the reading direction by 180 degrees, the user needs to touch-operate the direction setting button 727, and when rotating the reading direction by 270 degrees, the user needs to touch-operate the direction setting button 728. The reading direction is not limited to being set using the direction setting button 725 to 728, and for example, a UI in which the direction can be set using a radio button or the like may be displayed.

The UI 729 uses a check box and a text box to display whether to execute collation inspection for a reference character string of the CSV file set in the UI 721 and a read character string such that it can be set in accordance with inspection settings by the user. That is, whether to execute collation inspection corresponds to whether a check is inputted in the check box. In addition, if the checkbox is checked, an input value inputted in the text box is a column number in the CSV file, and a character string described in that column is used as a reference character string in the inspection.

An input value that can be accepted in the text box is an integer greater than or equal to 1, and the upper limit of the input value may be a maximum number of columns of the CSV file when it is read in advance. In addition, although it is assumed that the value inputted in the text box is a column number to be referenced, a pull-down UI for which the first row of variable data is read in advance and in which that first row is assumed as label values may be provided. In addition, a UI in which a column number to be referenced in the CSV file can be designated may be provided. Meanwhile, if the check box is not checked, collation inspection is not performed. In such a case, the text box in which the column number in which the reference string is described is to be inputted may be configured such that input cannot be made, such as being grayed out.

Further, a button 730 is a button for accepting an operation to execute inspection after all inspection settings have been completed. A button 731 is a button for accepting an operation to cancel inspection settings. When the user touch-operates the button 731, information being set is discarded and inspection settings are terminated. Even after the inspection settings in FIG. 7 are completed, the inspection settings can be adjusted again by being called by the user.

### <UI Related to Print/Discharge Settings at Time of Inspection>

An example of a UI related to print/discharge settings at the time of inspection in step S303 will be described with reference to FIG. 6. A UI screen 600 illustrated in FIG. 6 is displayed on the user interface unit 118 of the inspection PC 110 at a timing when print/discharge settings for pre-printing print settings are performed. The UI screen 600 displays a setting for the number of copies, a discharge setting, a setting when an inspection is determined to be NG, and a setting for shifting of a sheet for marking that sheet (NG sheet) when an inspection is determined to be NG such that they can be inputted.

More specifically, a text box 610 is a box in which the user can input the total number of copies of original data. In addition, radio buttons 620 displayed in a discharge setting region are displayed such that the user can select whether to discharge a printed material to the tray unit 290 by shift sorting or by group sorting at the time printing. Here, shift sorting is a setting in which, when there are two or more copies of original data, for example, the original data is printed in page order, and each copy is grouped as printed materials and discharged. Meanwhile, group sorting is a setting in which original data is printed such that they are grouped in page units, for the number of copies, and the copies for a respective page are grouped as printed materials and discharged.

Radio buttons 630 are displayed such that, when inspection NG is determined in image inspection or data inspection, the user can select a discharge destination of an NG sheet and whether to reprint the NG sheet page. When a normal tray (no reprinting) is selected, an inspection mode in which an NG sheet is discharged to the tray unit 290 (normal tray) similarly to an OK sheet and an NG page is not reprinted is assumed. That is, printed materials discharged to the tray unit 290 include an NG sheet. In addition, when a paper discharge tray (no reprinting) is selected, an NG sheet is discharged to the paper discharge unit 291, and an NG page is not reprinted. That is, an NG sheet is excluded from printed materials discharged to the tray unit 290. In addition, when a paper discharge tray (reprinting) is selected, an NG sheet is discharged to the paper discharge unit 291, and an NG page is reprinted. That is, when there is no abnormality in reprinted printed materials, the printed materials discharged to the tray unit 290 are printed materials determined to be inspection OK in all the pages.

Radio buttons 640 are displayed such that, when inspection NG is determined in image inspection or data inspection, the user can select whether to shift a sheet in a predetermined direction to mark an NG sheet. A setting for sheet shifting by using the radio buttons 640 is a setting for shifting a discharge position of a sheet to mark an NG sheet when inspection NG occurs, and is performed separately from processing for shifting a printed material at a normal time, which accords with the setting of the radio buttons 620. That is, when sheet shifting “none” is selected, sheet shifting for marking an NG sheet is not performed, and regarding shift processing, only normal shift processing, which accords with the setting of the radio buttons 620, is performed. Further, when “sheet shifting” is selected, shift processing at the time of normal printing, which accords with the setting of the radio buttons 620, is performed, and when an NG occurs in the inspection, a sheet for marking of NG is further shifted.

Further, when “rotation sorting” is selected, shift processing at the time of normal printing, which accords with the setting of the radio buttons 620, is performed, and when an NG occurs in the inspection, a sheet for marking of NG is further rotated by 90 degrees. If a normal tray (no reprinting) or a paper discharge tray (reprinting) is selected using the radio buttons 630, buttons for changing the setting values of the radio buttons 640 may be enabled. Meanwhile, if a paper discharge tray (reprinting) is selected using the radio buttons 630, buttons for changing the setting value of the radio buttons 640 may be disabled. In addition, when the setting value of the radio buttons 640 is selected to be “none” and a paper discharge tray (reprinting) is selected using the radio buttons 630, the setting value of the radio buttons 640 may be automatically changed to sheet shifting. In addition, when it is assumed that a sheet will not fit in the tray unit 290 when rotated, rotation sorting may be displayed to be unselectable or hidden. In addition, if a mechanism that can rotate sheets is not provided, or if there is a possibility that printing productivity may decrease due to rotation, the rotation sorting radio button may be displayed to be unselectable or the button itself may be hidden.

A button 650 is displayed to be operable by the user to execute inspection after print/discharge settings at the time of inspection is completed. A button 651 is a button for interrupting print/discharge settings at the time of inspection, and when the user performs a touch operation, information being set is discarded, and the print/discharge settings at the time of inspection are terminated. After the print/discharge settings at the time of inspection of FIG. 6 are terminated, the user can perform these settings again by calling print settings.

### <Example of Final Printed Material for Each Tray>

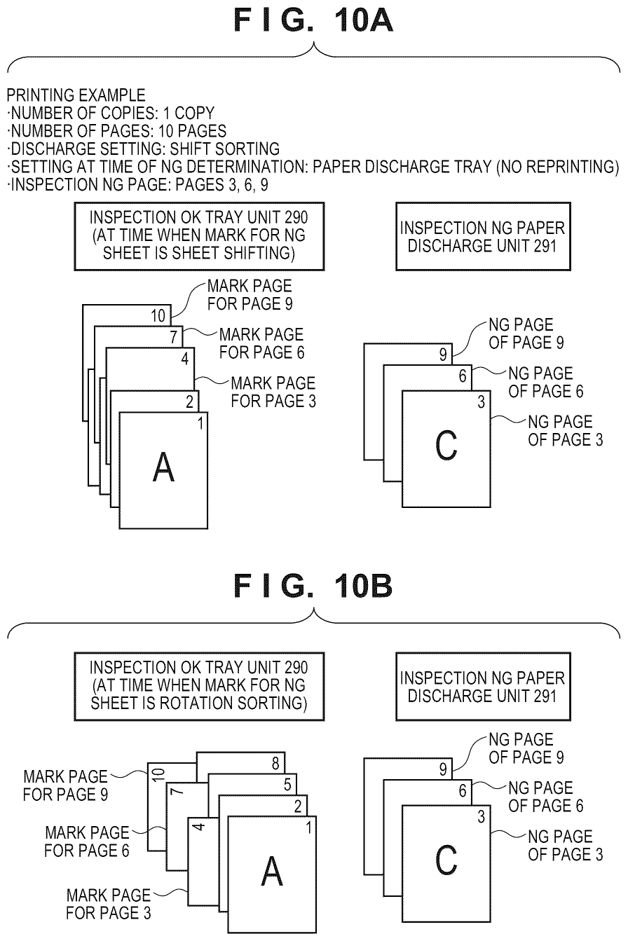

The states of trays on which inspected printed materials are stacked will be described with reference to FIGS. 10A, 10B, 11, 15A, and 15B. FIGS. 10A and 10B illustrate a case where one copy of 10-page original data, for example, is printed. Here, it is assumed that a discharge setting is set to shift sorting, and in addition, a setting is made to discharge an NG sheet (an example of a “second sheet”) to a paper discharge tray (no reprinting) at the time of NG determination. In addition, it is assumed that OK sheet (an example of a “first sheet”) pages are page 1, 2, 4, 5, 7, 8, and 10, and that NG sheet pages are pages 3, 6, and 9. Further, FIG. 10A illustrates the state of printed materials discharged to the tray unit 290 when sheet shifting for marking an NG sheet is set to “sheet shifting” in a screen as in FIG. 6. Meanwhile, FIG. 10B illustrates the state of printed materials discharged to the tray unit 290 when sheet shifting for marking an NG sheet is set to “rotation sorting”.

In FIG. 10A, OK sheets are discharged to the tray unit 290, and NG sheets are discharged to the paper discharge unit 291. Then, OK sheets of pages 4, 7, and 10, which are pages after an NG sheet, are shifted in a lengthwise direction of the sheet surface (an example of a “first direction” and a “direction parallel to a surface of the first sheet”) relative to a sheet of a preceding/succeeding page as a mark that an NG sheet occurred and stacked. Such a mark sheet is used to insert an NG sheet between OK sheets stacked on the tray unit 290 if it is visually confirmed that there are no abnormalities in the quality of the NG sheet, for example. In addition, it is similarly used to insert a reprinted sheet between OK sheets stacked on the tray unit 290, when an NG sheet is reprinted after printing of all the pages is completed and it is visually confirmed that there are no abnormalities in the quality of the reprinted sheet. When A4 standard sheets are set in the paper feeding unit 250 in a state in which they are rotated by 90 degrees, such as in an A4R standard, an OK sheet to be a mark may be shifted in a widthwise direction of the sheet. The OK sheets of pages 4, 7, and 10 are examples of a “preceding/succeeding sheet” and a “mark sheet”.

In FIG. 10B, OK sheets are discharged to the tray unit 290, and NG sheets are discharged to the paper discharge unit 291. However, in the case of FIG. 10B, OK sheets of pages 4, 7, and 10, which are pages after an NG sheet, are rotated by 90 degrees about a stacking direction (an example of “rotational shifting about an axis perpendicular to the surface of the first sheet”) as a mark that an NG sheet occurred. Such a mark sheet is used to insert a sheet visually confirmed to have no abnormalities in quality, as an OK sheet, between OK sheets stacked on the tray unit 290.

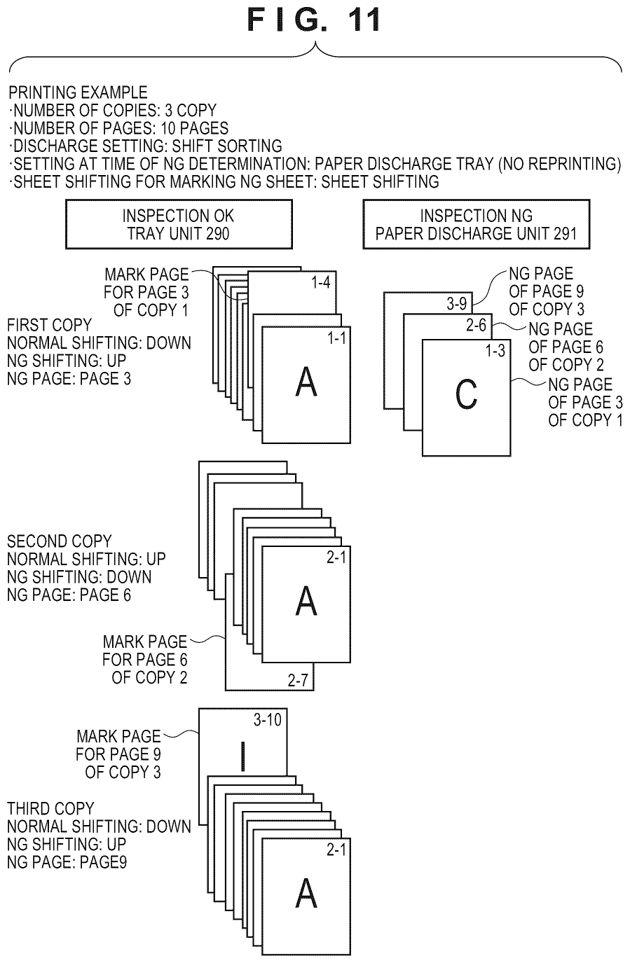

FIG. 11 illustrates a case where three copies (an example of “a plurality of copies”) of 10-page original data are printed. Here, it is assumed that a discharge setting is set to shift sorting, and a discharge setting at the time of inspection is set to discharge an NG sheet to a paper discharge tray (no reprinting) at the time of NG determination. In FIG. 11, it is assumed that an NG sheet occurred on page 3 of the first copy, page 6 of the second copy, and page 9 of the third copy. That is, OK sheet pages in the first copy are pages 1, 2, and 4 to 10, in the second copy are pages 1 to 5 and 7 to 10, and in the third copy are pages 1 to 8 and 10, and are discharged to the tray unit 290 side. Meanwhile, page 3 of the first copy, page 6 of the second copy, and page 9 of the third copy, which are determined to be inspection NG, are discharged to the paper discharge unit 291 as NG sheets.

Since the discharge setting is set to shift sorting, a normal discharge position is shifted when one copy is printed. That is, the first copy is shifted downward in FIG. 11, for example, the second copy is shifted in a direction opposite to that of the first copy, and the third copy is shifted in the same direction as that of the first copy again and discharged. This makes it possible to determine a boundary between copy units in accordance with shifting of the position of the sheets. Such shifting is an example of “for each copy, among the first sheets, shift a sheet other than the mark sheet in a direction different from a shift direction of a preceding/succeeding copy”. Meanwhile, sheet shifting for marking an NG sheet is also set to “sheet shifting”. However, sheet shifting for marking an NG sheet is performed in a direction opposite to normal discharge shifting. For example, a mark page (page 4) for page 3 of the first copy is shifted upward relative to a bundle of OK sheets of the first copy, which are shifted downward in FIG. 11. Such a mark sheet is used to insert a sheet visually confirmed to have no abnormalities in quality between OK sheets stacked on the tray unit 290. Thus shifting and discharging to the tray unit 290 is an example of “outputting such that a mark sheet is shifted in a direction opposite to a shift direction of a copy in which the mark sheet is included”.

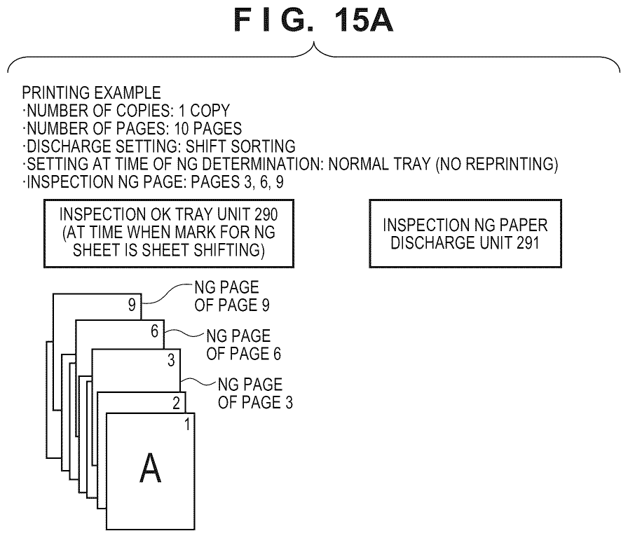

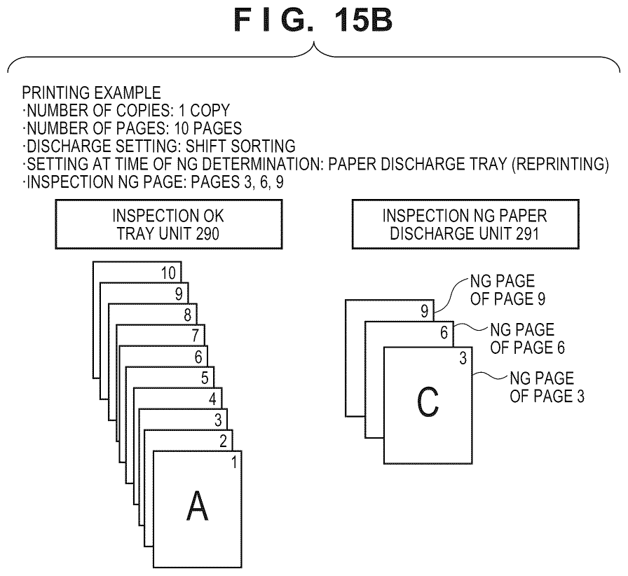

FIG. 15A illustrates a case where one copy of 10-page original data, for example, is printed. Here, it is assumed that a discharge setting is set to shift sorting, and in addition, a setting is made to discharge an NG sheet to a normal tray (no reprinting) at the time of NG determination. In FIG. 15A, it is assumed that pages where an NG sheet occurred are pages 3, 6, and 9.

In such a case, pages 1, 2, 4, 5, 7, 8, and 10, which are determined to be inspection OK, are discharged to the tray unit 290. In addition, NG sheets of pages 3, 6, and 9 are discharged not to the paper discharge unit 291 but to the tray unit 290 (an example of the “same discharge unit”), which is a normal tray. Here, pages 3, 6, and 9 are shifted in a lengthwise direction of a sheet surface (an example of a “second direction”) relative to a sheet of a preceding/succeeding page as a mark for inspection NG and stacked. Such a mark sheet is used to insert an NG sheet as an OK sheet between sheets stacked on the tray unit 290 if it is visually confirmed that there are no abnormalities in the quality of the NG sheet, for example. It is similar for when an NG sheet is reprinted and it is confirmed that there are no abnormalities in the quality of the reprinted sheet. A shift direction of an NG sheet in FIG. 15A may be the same as or different from the shift direction of an OK sheet in FIG. 10A.

FIG. 15B illustrates a case where one copy of 10-page original data, for example, is printed. Here, it is assumed that a discharge setting is set to shift sorting, and in addition, a setting is made to discharge an NG sheet to a paper discharge tray (reprinting) at the time of NG determination. In FIG. 15B, it is assumed that pages where an NG sheet occurred are pages 3, 6, and 9.

In such a case, at the time of NG determination, that page is discharged to the NG paper discharge unit 291 and reprinted. Therefore, a reprinted sheet determined to be inspection OK is ultimately discharged to the tray unit 290, and as a result, a printed material in which all of the pages are present is stacked on the tray unit 290. Therefore, the processing of shifting the position of an OK sheet as a mark for an NG sheet becomes unnecessary. Until reprinting and inspection OK is achieved, the image of the next page will not be inspected and discharged in accordance with the inspection result.

In FIG. 15B, a subsequent sheet being printed may be discharged to the paper discharge unit 291 on which NG sheets are to be stacked. For example, if page 4 is already printed when page 3 is determined to be inspection NG, page 4 is also discharged to the paper discharge unit 291 together with page 3. Pages 3 and 4 may then be reprinted.

### Processing Example 2

A flowchart of processing for inspecting whether there is an abnormal image in a printed material in the inspection PC 110 when the user prints using the image forming apparatus 100 via the printer server 130 will be described with reference to FIG. 4. This flowchart is started, triggered by the user performing an input operation to start inspection on the user interface unit 118 in the inspection PC 110 after completing settings in step S303, and inspection being started in step S304. This flowchart is executed by program code stored in the storage unit 116 of the inspection PC 110 being deployed into the RAM 113 and the apparatus control unit 111 being controlled by the CPU 112.

This flowchart is a flowchart for when discharging an NG sheet. In addition, it is assumed that a setting at the time of NG determination is set to a paper discharge tray (no reprinting). That is, by such a series of processes being executed, NG sheets are separated from OK sheets and stacked in the paper discharge unit 291, and OK sheets including a mark that inspection NG has occurred are stacked in the inspection OK tray unit 290, as in FIG. 10A or 10B.

In step S401, the CPU 112 of the inspection PC 110 obtains inspection settings stored in the storage unit 116 in step S302. In step S402, the CPU 112 causes the operation status of the inspection PC 110 to transition to a scan standby state. In step S403, the CPU 112 determines content inputted via the user interface unit 118. If the CPU 112 determines that the input content indicates scanning of an image, the processing proceeds to step S404, and if the CPU 112 determines that the input content instructs to complete inspection, the process proceeds to step S414.

In step S404, the CPU 112 executes processing for aligning a scanned image and a reference image. In step S405, the CPU 112 obtains a difference between a picture image included in the scanned image and the reference image. In step S406, the CPU 112 determines whether the difference is less than a predetermined value. If the CPU 112 determines that the difference is less than the predetermined value, the processing proceeds to step S407 as image inspection OK, and if the CPU 112 determines that the difference is greater than or equal to the predetermined value, the processing proceeds to step S408 as image inspection NG.

In step S407, the CPU 112 executes data inspection in which a degree of matching of symbol data included in the scanned image with reference data is calculated and whether data is the reference data is determined. If the CPU 112 determines that the degree of matching is greater than or equal to a predetermined value, the processing proceeds to step S409 as data inspection OK. Meanwhile, if the CPU 112 determines that the degree of matching is less than the predetermined value, the processing proceeds to step S408 as data inspection NG. In this flowchart, although image inspection and data inspection are executed in that order, configuration may be taken such that data inspection and image inspection are executed in parallel and if an NG occurs in one of the two inspection results, the processing proceeds to step S408.

In step S408, the CPU 112 transmits an instruction to discharge a sheet on which the scanned image is formed to the inspection NG paper discharge unit 291 to the image forming apparatus 100 by using the communication I/F unit 115. In the image forming apparatus 100, the communication I/F unit 264 of the inspection unit 102 receives the instruction. Then, the CPU 281 of the apparatus control unit 280 of the finisher 103 executes discharge in accordance with the instruction. The instruction also includes print/discharge setting information set via the UI screen 600 in FIG. 6. Then, the processing proceeds to step S413. In step S409, the CPU 112 determines whether the preceding page of the page being inspected is inspection OK. Then, if the CPU 112 determines that the preceding page is inspection OK, the processing proceeds to step S412, and otherwise, the processing proceeds to step S410.

In step S410, the CPU 112 determines whether shift sorting or group sorting is set as the discharge setting. Then, if the CPU 112 determines that shift sorting is set, the process proceeds to step S411. Meanwhile, if the CPU 112 determines that group sorting is set, the process proceeds to step S412. In step S411, the CPU 112 performs setting so as to perform discharge at a position different from a discharge position at a normal time in order to perform sheet shifting for marking inspection NG.

When group sorting is set in the discharge setting, an OK sheet is discharged at a discharge position at a normal time. The reason for this is that, in group sorting, sheets printed for the number of copies per page (e.g., 10 copies per page) are set as one group, and the sheet position is shifted for each group. Therefore, a sheet group determined to be NG can easily be recognized. When group sorting is set, sheet shifting may be executed to mark inspection NG.

In step S412, the CPU 112 transmits an instruction to discharge an OK sheet to the inspection OK tray unit 290 to the image forming apparatus 100 by using the communication I/F unit 115. In the image forming apparatus 100, the communication I/F unit 264 of the inspection unit 102 receives the instruction. Then, the CPU 281 of the apparatus control unit 280 of the finisher 103 executes discharge in accordance with the instruction. The instruction also includes print/discharge setting information set via the UI screen 600 in FIG. 6. That is, the CPU 112, in a normal case, discharges an OK sheet at a position corresponding to the copy number, and in a case where a shift change has been made in step S411, transmits an instruction to discharge an OK sheet at a different position set in step S411 to the image forming apparatus 100. Here, a shift position of an OK sheet is, for example, a position shifted by a predetermined amount in a direction parallel to the sheet surface or a position rotated by a predetermined amount about a direction perpendicular to the sheet surface, relative to a preceding/succeeding OK sheet stacked on the tray unit 290.

In step S413, the CPU 112 temporarily stores an inspection result determined in steps S406 and S407 in a storage medium such as the RAM 113. The inspection result is used in determination processing of step S409 for the next page. Then, the processing returns to step S402.

When a setting at the time of NG determination is set to the paper discharge tray (reprinting), reprinting is executed each time an abnormal image is detected, and as a result, OK sheets having no abnormal images for all of the pages are stacked on the tray unit 290 of the finisher.

If it is determined that the entire print data has been printed and inspected, the CPU 261 of the inspection unit 102 of the image forming apparatus 100 controls the communication I/F unit 264 to transmit an inspection completion instruction to the inspection PC 110. Then, in step S403, the CPU 112 of the inspection PC 110 receives the inspection completion instruction via the communication I/F unit 115. Then, in step S414, the CPU 112 stores the inspection result in the storage unit 116 together with the inspection settings called in step S401. However, since it is difficult to store scanned images in the RAM 113 due to their large size, the CPU 112 may store a scanned image in the storage unit 116 after inspection of each sheet. Then, the CPU 112 terminates the processing.

### Processing Example 3

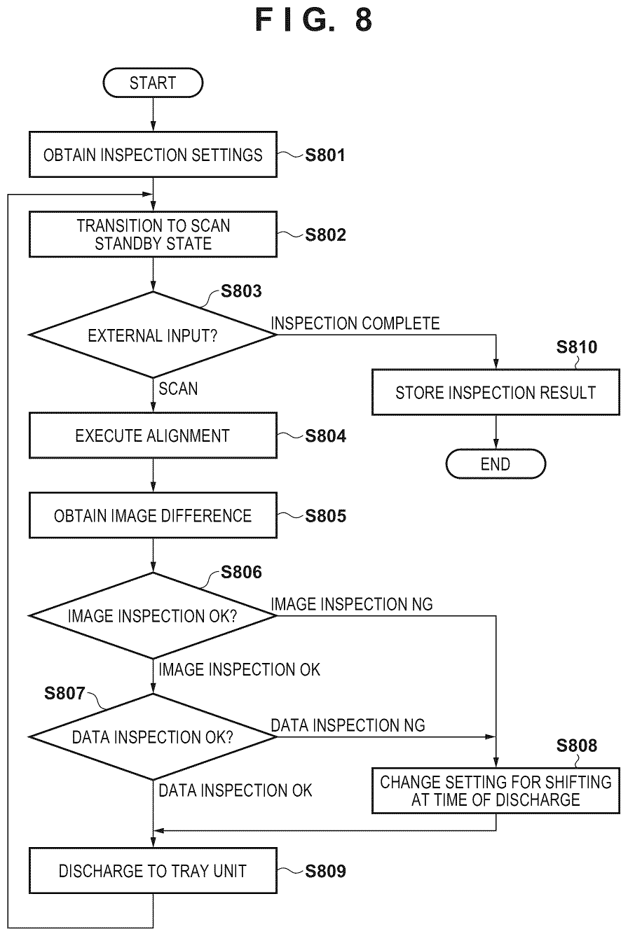

Another example of a flowchart of processing for inspecting whether there is an abnormal image in a printed material in the inspection PC 110 will be described with reference to FIG. 8. This flowchart is started, triggered by the user performing an input operation to start inspection on the user interface unit 118 in the inspection PC 110 after completing settings in step S303, and inspection being started in step S304. This flowchart is executed by program code stored in the storage unit 116 of the inspection PC 110 being deployed into the RAM 113 and the apparatus control unit 111 being controlled by the CPU 112.

It is assumed that a setting at the time of NG determination is set to a normal tray (no reprinting). By such a series of processes being executed, NG sheets are not separated from OK sheets and are stacked in the inspection OK tray unit 290, as in FIG. 15A. Further, steps S801 to S808 and S810 correspond to steps S401 to S408 and S414 and thus will not be described.

In step S809, the CPU 112 transmits an instruction to discharge an OK sheet and an NG sheet to the inspection OK tray unit 290 to the image forming apparatus 100 by using the communication I/F unit 115. In the image forming apparatus 100, the communication I/F unit 264 of the inspection unit 102 receives the instruction. Then, the CPU 281 of the apparatus control unit 280 of the finisher 103 executes discharge in accordance with the instruction. The instruction also includes print/discharge setting information set via the UI screen 600 in FIG. 6. That is, the CPU 112, in a normal case, discharges an OK sheet at a position corresponding to the copy number, and in a case where a shift change has been made in step S808, transmits an instruction to shift and discharge an NG sheet at a position different from that of the normal case set in step S808 to the image forming apparatus 100. Here, a different position is, for example, a position shifted by a predetermined amount in a direction parallel to the sheet surface or a position rotated by a predetermined amount about a direction perpendicular to the sheet surface, relative to a preceding/succeeding OK sheet stacked on the tray unit 290. Then, the processing returns to step S802.

### Processing Example 4

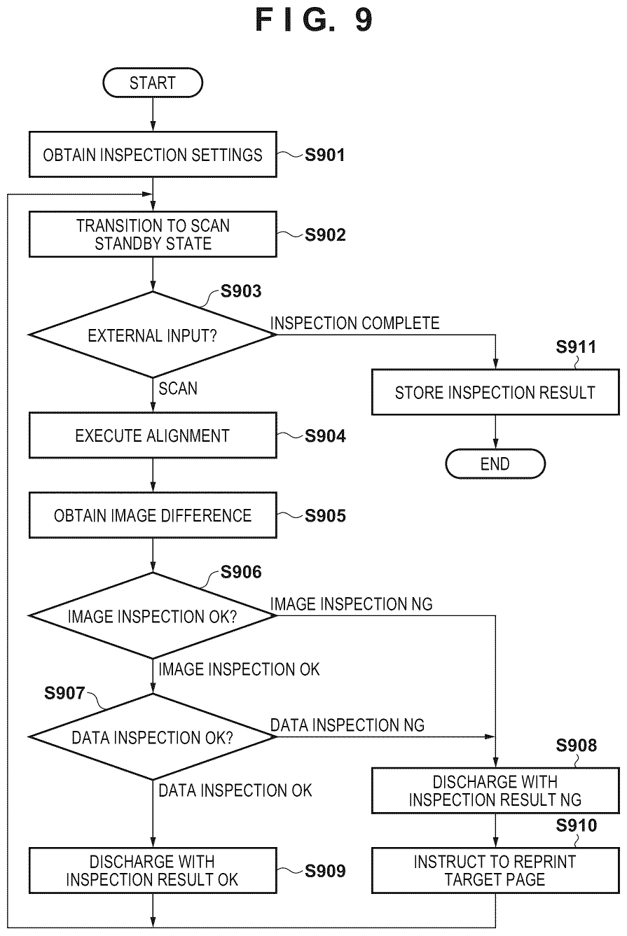

Another example of a flowchart of processing for inspecting whether there is an abnormal image in a printed material in the inspection PC 110 will be described with reference to FIG. 9. This flowchart is started, triggered by the user performing an input operation to start inspection on the user interface unit 118 in the inspection PC 110 after completing settings in step S303, and inspection being started in step S304. This flowchart is executed by program code stored in the storage unit 116 of the inspection PC 110 being deployed into the RAM 113 and the apparatus control unit 111 being controlled by the CPU 112.

It is assumed that a setting at the time of NG determination is set to a paper discharge tray (reprinting). That is, by such a series of processes being performed, the page is discharged to the NG paper discharge unit 291 at the time of NG determination and reprinted, as in FIG. 15B. Therefore, a reprinted sheet determined to be inspection OK is ultimately discharged to the tray unit 290, and as a result, a printed material in which all of the pages are present is stacked on the tray unit 290. Therefore, a page where inspection NG occurred can easily be recognized by confirming the paper discharge unit 291. Therefore, the processing of shifting the position of an OK sheet as a mark for a sheet determined to be inspection NG becomes unnecessary. Further, steps S901 to S909 and S911 correspond to steps S401 to S408, S412, and S414 and thus will not be described.

In step S910, the CPU 112 controls the communication I/F unit 115 to transmit a request to reprint starting from the page determined to be inspection NG to the image forming apparatus 100. Then, the processing returns to step S902. Until the page determined to be NG is reprinted and is determined to be inspection OK, the next page will not be subject to image inspection and discharged in accordance with the inspection result.

### <Screen of List of Inspection Results>

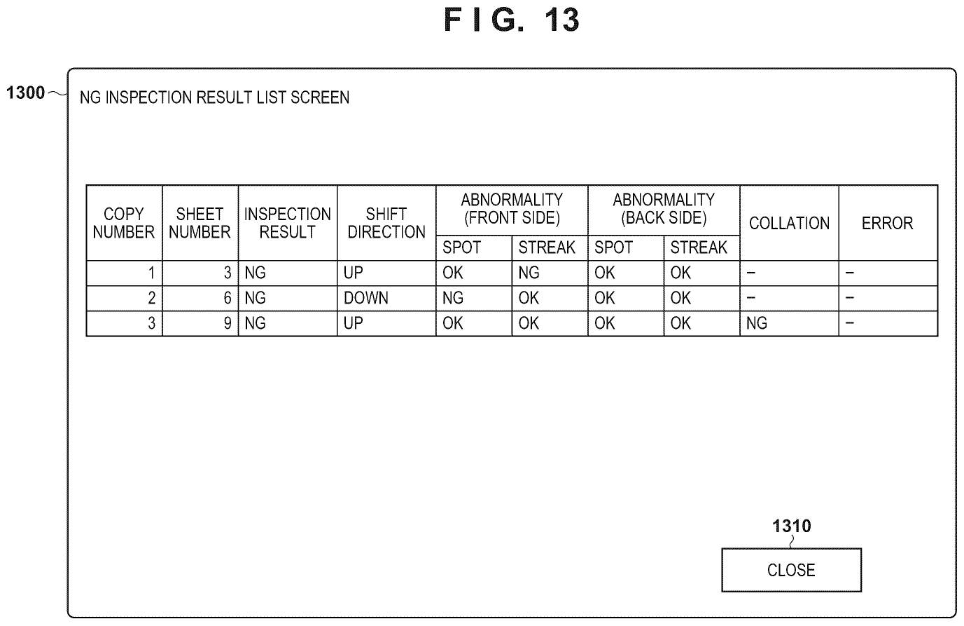

A UI for displaying detailed information on an NG sheet and an inspection result when the processing indicated in FIG. 4 is executed will be described with reference to FIG. 13. The user interface unit 118 of the inspection PC 110 displays a UI screen 1300 illustrated in FIG. 13. The information displayed on the UI screen 1300 is, for example, a copy number, a sheet number, an inspection result, a direction in which the sheet is shifted, an inspection result of spots and streaks on the front side/back side of the sheet, a collation result of data inspection related to characters, and the presence or absence of an error in inspection. Further, the UI screen 1300 is provided with a button 1310 for terminating screen display.

The UI screen 1300 displays a shift direction of an OK sheet serving as a mark for an NG page. Therefore, even when the print direction is shifted for each copy as illustrated in FIG. 11, by the user visually confirming the UI screen 1300, it is possible to reduce misunderstanding of the shift direction of an OK sheet serving as a mark. The user interface unit 118 may display the UI screen 1300 displaying in a pop-up a thumbnail image of an inspection NG page, a thumbnail image of a page serving as a mark for inspection NG, and the like. With such a UI screen 1300, it is also possible to easily recognize an inspection NG page.

### One Aspect of Effect/Advantage

According to the inspection system 1 as described above, the user can easily recognize a page where inspection NG occurred. Therefore, the user can easily insert, at a position where an NG sheet occurred, a sheet visually confirmed to have no abnormalities or a sheet determined to be inspection OK after reprinting an image formed on a sheet determined to be NG in inspection. Further, according to the inspection system 1 as described above, since an insert sheet or an inter sheet does not need to be fed as a mark for a page where an NG sheet occurred, sheet consumption is reduced.

### Modification

### <Example of Final Printed Material for Each Tray>

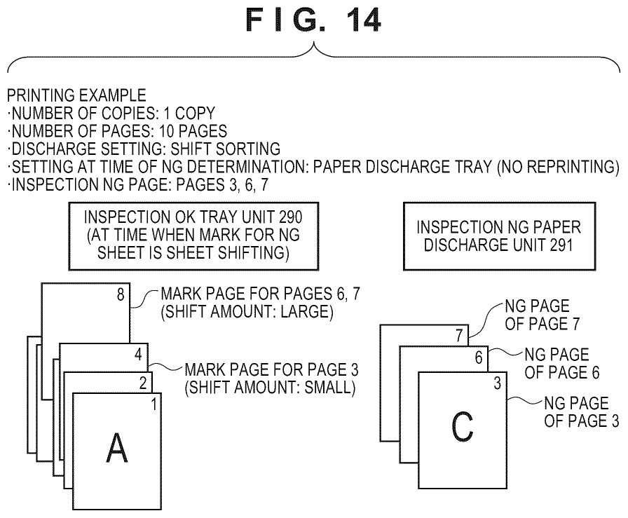

A final printed material in a tray after processing according to a modification is executed will be described with reference to FIG. 14. In FIG. 14, it is assumed, for example, one copy of 10-page original data is printed and a setting at the time of NG determination is set to paper discharge tray (no reprinting). It is assumed that the pages determined to be inspection NG are pages 3, 6, and 7.

When the processing according to the modification is executed, while OK sheets subjected to sheet shifting for marking an NG sheet are discharged to the tray unit 290, NG sheets are discharged to the paper discharge unit 291. More specifically, the sheets of pages 1, 2, 4, 5, 8, 9, and 10, which have been determined to be inspection OK, are discharged to the tray unit 290, and the sheets of pages 3, 6, and 7, which have been determined to be inspection NG are discharged to the inspection NG paper discharge unit 291. In such a case, OK sheets of pages 4 and 8 after an NG page, are shifted in sheet position when they are discharged, as a mark for inspection NG. Furthermore, when the position of a sheet in the tray unit 290 can be shifted in two steps, a shift amount of the position of a mark when only one sheet is determined to be NG and a shift amount of the position of a mark for consecutive NGs are changed. For example, a shift amount of an OK sheet of page 4, which serves as a mark for an NG sheet of page 3, is decreased, and a shift amount of an OK sheet of page 8, which serves as a mark for an NG sheet of pages 6 and 7, is increased. Such a mark sheet is used to insert a sheet for which it is confirmed that there are no abnormalities in its quality between sheets stacked on the tray unit 290 if it is visually confirmed that there are no abnormalities in the quality of an NG sheet determined to be inspection NG, for example. It is similar for when an NG sheet is reprinted after printing of all the pages is completed and it is confirmed that there are no abnormalities in the quality of the reprinted sheet. In addition, since a shift amount is increased for the positions of consecutive NGs, it is possible to prompt the user to pay attention to insertion at these positions.

### Processing Example 5

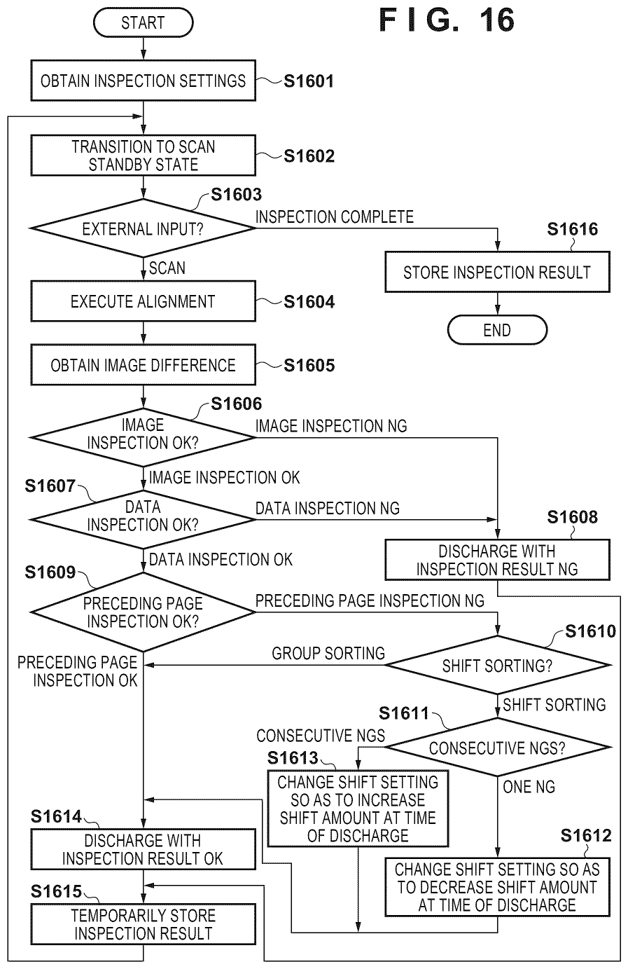

A flowchart of processing for inspecting whether there is an abnormal image in a printed material in the inspection PC 110 according to the modification will be described with reference to FIG. 16. This flowchart is started, triggered by the user performing an input operation to start inspection on the user interface unit 118 in the inspection PC 110 after completing settings in step S303, and inspection being started in step S304. This flowchart is executed by program code stored in the storage unit 116 of the inspection PC 110 being deployed into the RAM 113 and the apparatus control unit 111 being controlled by the CPU 112.

It is assumed that a setting at the time of NG determination is set to a paper discharge tray (no reprinting). That is, by such a series of processes being executed, while NG sheets are separated from OK sheets and stacked in the paper discharge unit 291, printed materials including OK sheets serving as a mark for inspection NG are stacked in the inspection OK tray unit 290, as in FIG. 14. Further, steps S1601 to S1610, S1615, and S1616 are similar to steps S401 to S410, S413, and S414 and thus will not be described.

In step S1611, the CPU 112 of the inspection PC 110 determines whether there are consecutive inspection NGs. If the CPU 112 determines that there are consecutive inspection NGs, the processing proceeds to step S1613, and otherwise, the processing proceeds to step S1612. In step S1613, the CPU 112 performs setting so as to perform discharge at a position different from a discharge position at a normal time in order to perform sheet shifting for marking inspection NG. Here, in order to facilitate recognition that there are consecutive NGs, the CPU 112 sets the discharge position such that a shift amount (an example of “change in the shift amount”) is greater than a normal shift amount, such as when shifting for each copy.

In step S1612, the CPU 112 performs setting so as to perform discharge at a position different from a discharge position at a normal time in order to perform sheet shifting for marking inspection NG. Here, in order to facilitate recognition that there are no consecutive NGs, the CPU 112 sets the discharge position such that a shift amount (an example of “change in the shift amount”) is less than a normal shift amount.

In step S1614, the CPU 112 transmits an instruction to discharge an OK sheet to the inspection OK tray unit 290 to the image forming apparatus 100 by using the communication I/F unit 115. In the image forming apparatus 100, the communication I/F unit 264 of the inspection unit 102 receives the instruction. Then, the CPU 281 of the apparatus control unit 280 of the finisher 103 executes discharge in accordance with the instruction. The instruction also includes print/discharge setting information set via the UI screen 600 in FIG. 6. That is, in a normal case, the CPU 112 transmits an instruction to shift and discharge an OK sheet at a position corresponding to the copy number to the image forming apparatus 100. In addition, if the shift setting is changed in step S1612 or S1613, the CPU 112 transmits an instruction to shift the OK sheet by the amount set in step S1612 or S1613 and discharge the OK sheet to the image forming apparatus 100.

Although the shift amount is in three steps (large, normal, small), as long as there is no problem in the discharged sheet stacking performance, the shift amount may be set to have more steps. In addition, configuration may be taken so as to shift a mark page for consecutive NGs by a normal shift amount and further rotate the mark page by 90 degrees by rotation sorting. Here, rotation sorting refers to shifting by rotation about an axis perpendicular to the surface of the sheet and outputting. Further, a pop-up UI may be displayed to issue a warning for the position where consecutive NGs occurred. By doing so, it becomes easy to recognize the position where consecutive NGs occurred. Therefore, the user can easily insert sheets determined to be inspection OK after reprinting images formed on sheets determined to be consecutive NGs in inspection.

### Another Modification

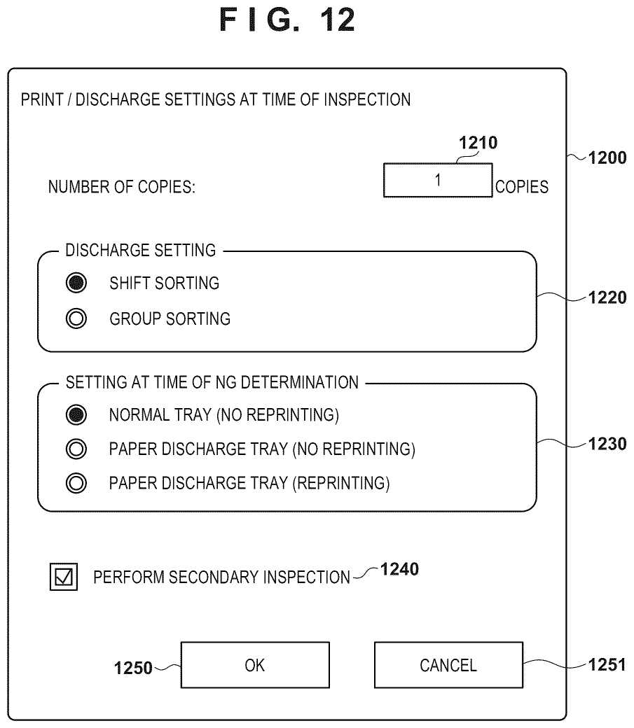

Another example of a UI related to print/discharge settings at the time of inspection in step S303 will be described with reference to FIG. 12. Radio buttons 1230 in a UI screen 1200 in FIG. 12 are similar to the radio buttons 630 in the UI screen 600 in FIG. 6 and thus will not be described.

A check box 1240 allows input of whether to separately perform secondary inspection after inspection by an inspection application. The user checks the check box when they wish to perform secondary inspection. In such a case, the CPU 112 accepts execution of secondary inspection via the user interface unit 118. Then, the CPU 112 automatically sets a setting for sheet shifting for marking an OK sheet to “sheet shifting” or “rotation sorting”. In such a case, it is used to insert a sheet confirmed to have no abnormalities in quality between sheets stacked on the tray unit 290 if it is visually confirmed that there are no abnormalities in its quality of an NG sheet determined to be inspection NG, for example. It is similar for when an NG sheet is reprinted after printing of all the pages is completed and it is confirmed that there are no abnormalities in the quality of the reprinted sheet. Even when execution of secondary inspection can be determined from the inspection application, a setting for sheet shifting for marking an OK sheet may be automatically set to “sheet shifting” or “rotation sorting”.

Further, although shifting for marking according to the embodiments is executed on a sheet of the page after a sheet determined to be inspection NG, sheet shifting is not limited to being executed on an OK sheet of the page after an NG sheet, and may be executed on an OK sheet that is two or more pages after the NG sheet (an example of a “preceding/succeeding sheet”). In addition, when the sheet conveyance path length from the inspection unit 102 to the finisher 103 is sufficiently long, for example, sheet shifting may be executed on an OK sheet of a page before a sheet determined to be inspection NG or a page further before that page. A sheet subjected to these kinds of shifting is an example of a “sheet preceding/succeeding the second sheet”.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-166561, filed Sep. 25, 2024, which is hereby incorporated by reference herein in its entirety.

What is claimed is:

1. An image forming apparatus comprising:
one or more memory devices that store a set of instructions; and
one or more processors that execute the set of instructions to:
form an image on a plurality of sheets;
read the plurality of sheets on which the image has been formed;
obtain a result of determination as to whether there is an abnormality on the read plurality of sheets; and
based on the obtained determination result, output the plurality of sheets such that a sheet determined to have an abnormality among the plurality of sheets can be identified, wherein
the one or more processors execute instructions in the one or more memory devices to:
perform control so as to output a first sheet determined to have no abnormalities and a second sheet determined to have an abnormality to respective different discharge units, and
among first sheets, shift at least one sheet preceding/succeeding the second sheet as a mark sheet in a first direction and output the sheet.

2. The image forming apparatus according to claim 1, wherein
the one or more processors execute instructions in the one or more memory devices to:
in a case where the image is formed on sheets of a plurality of copies
for each copy, among the first sheets, shift a sheet other than the mark sheet in a direction different from a shift direction of a preceding/succeeding copy and output the sheet, and
output the mark sheet in a state further shifted relative to the shifted and outputted copy.

3. The image forming apparatus according to claim 1, wherein
the one or more processors execute instructions in the one or more memory devices to:
in a case where the second sheet has occurred in consecutive pages, change a shift amount of the mark sheet in accordance with an amount of the consecutive pages.

4. The image forming apparatus according to claim 1, wherein
the one or more processors execute instructions in the one or more memory devices to:
shift the mark sheet in a direction parallel to a surface of the first sheet or shift the mark sheet by rotation about an axis perpendicular to the surface, and output the mark sheet.

5. The image forming apparatus according to claim 1, wherein
the one or more processors further execute instructions in the one or more memory devices to:
further perform control so as to shift the second sheet determined to have an abnormality in a second direction relative to the first sheet determined to have no abnormalities, and output the first sheet and the second sheet to the same discharge unit.

6. An image forming system comprising:
the image forming apparatus according to claim 1; and
an inspection apparatus, wherein
the one or more processors in the image forming apparatus further execute instructions in the one or more memory devices to:
transmit images of the read plurality of sheets to the inspection apparatus,
the inspection apparatus comprising:
one or more memory devices that store a set of instructions; and
one or more processors that execute the set of instructions to:
receive the images of the plurality of sheets transmitted by the image forming apparatus; and
determine whether there is an abnormality in the received images of the plurality of sheets, wherein
the one or more processors in the inspection apparatus further execute instructions in the one or more memory devices to:
transmit a result of the determination to the image forming apparatus.

7. The image forming system according to claim 6, wherein
the one or more processors in the inspection apparatus execute instructions in the one or more memory devices to:
determine the images of the plurality of sheets including a picture or a symbol.

8. The image forming system according to claim 6, wherein
the one or more processors in the inspection apparatus further execute instructions in the one or more memory devices to:
generate a screen for setting outputting of the plurality of sheets.

9. The image forming system according to claim 8, wherein
the screen includes
a first object for selecting a setting for a sorting method at the time of outputting the plurality of sheets,
a second object for setting an output destination of the second sheet, and
a third object for setting shifting of the mark sheet.

10. The image forming system according to claim 9, wherein
in a case of forming the image on sheets of a plurality of copies, the first object includes an object for selecting shift sorting in which the first sheets are outputted in a group for each copy in page order, or group sorting in which the first sheets are outputted in a group for each page.

11. The image forming system according to claim 9, wherein
the second object includes an object for selecting to
output the second sheet to the same discharge unit as the first sheet without reforming the image formed on the second sheet,
output the second sheet to a discharge unit different from that of the first sheet without reforming the image formed on the second sheet, or
reform the image formed on the second sheet, and output the second sheet to a discharge unit different from that of the first sheet.

12. The image forming system according to claim 9, wherein
the third object includes an object for selecting to
not shift the mark sheet,
shift the mark sheet in a direction parallel to a surface of the first sheet, or
shift the mark sheet by rotation about an axis perpendicular to the surface of the first sheet.

13. A method of controlling an image forming apparatus, the method comprising:
forming an image on a plurality of sheets;
reading the plurality of sheets on which the image has been formed;
obtaining a result of determination as to whether there is an abnormality on the read plurality of sheets; and
based on the obtained determination result, outputting the plurality of sheets such that a sheet determined to have an abnormality among the plurality of sheets can be identified,
wherein
control is performed so as to output a first sheet determined to have no abnormalities and a second sheet determined to have an abnormality to respective different discharge units, and
among first sheets, at least one sheet preceding/succeeding the second sheet is shifted as a mark sheet in a first direction and output the sheet.
